(19) United States
(12) Patent Application Publication
(10) Pub. No.: US 2026/0299936 A1
(43) Pub. Date: Oct. 1, 2026

(54) APPARATUS, METHOD, AND COMPUTER PROGRAM PRODUCT FOR OUTPUTTING A CONFIGURATION CODE PULL REQUEST CONTRAST INTERFACE COMPONENT FOR RENDERING TO A CONFIGURATION CODE PULL REQUEST OPERATIONS INTERFACE

(71) Applicant: ATLASSIAN US, INC., San Francisco, CA (US)

(72) Inventors: Berat GÜMÜS, Izmir (TR); Tolunay KATIRCI, Istanbul (TR)

(21) Appl. No.: 19/092,633

(22) Filed: Mar. 27, 2025

(51) Int. Cl. G06F 8/71

(52) U.S. Cl. CPC G06F 8/71

(57) ABSTRACT

Apparatus, methods, and computer program products for outputting a configuration code pull request contrast interface component for rendering to a configuration code pull request operations interface are provided herein. For example, a method may include access a plurality of segmented configuration file repositories, identifying framework configuration files, executing a framework configuration file unification script, receiving a framework configuration code pull request, generating a framework configuration code contrast file, generating a configuration code pull request contrast interface component, and outputting the configuration code pull request contrast interface component for rendering to the configuration code pull request operations interface.

### BACKGROUND

Various methods, apparatuses, and systems provide tools to plan, update, execute, and monitor software development configurations and interface components in software development operations environments. Applicant has identified a number of deficiencies and problems associated with tools for effectively, reliably, and securely managing software development configurations and interface components in software development operations environments. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a configuration code pull request operations system, one or more interface components, such as a configuration code pull request contrast interface component.

In accordance with some exemplary embodiments of the present disclosure, an example apparatus for outputting a configuration code pull request contrast interface component for rendering to a configuration code pull request operations interface is provided. In some embodiments, the apparatus may comprise at least one processor and at least one memory including program code. In some embodiments, the at least one memory and the program code are configured to, with the at least one processor, cause the apparatus to access a plurality of segmented configuration file repositories. In some embodiments, the at least one memory and the program code are configured to, with the at least one processor, cause the apparatus to identify a first framework configuration file in a first segmented configuration file repository of the plurality of segmented configuration file repositories and a second framework configuration file in a second segmented configuration file repository of the plurality of segmented configuration file repositories. In some embodiments, the at least one memory and the program code are configured to, with the at least one processor, cause the apparatus to execute a framework configuration file unification script to transfer the first framework configuration file to a first framework configuration file directory in a joint framework configuration file repository and the second framework configuration file to a second framework configuration file directory in the joint framework configuration file repository. In some embodiments, the at least one memory and the program code are configured to, with the at least one processor, cause the apparatus to receive a framework configuration code pull request corresponding to the first framework configuration file. In some embodiments, the at least one memory and the program code are configured to, with the at least one processor, cause the apparatus to generate a framework configuration code contrast file by applying the framework configuration code pull request and a joint framework configuration file to a framework configuration code contrast model, wherein the framework configuration code contrast file comprises a framework configuration code contrast indicator. In some embodiments, the at least one memory and the program code are configured to, with the at least one processor, cause the apparatus to generate the configuration code pull request contrast interface component, wherein the configuration code pull request contrast interface component comprises a framework configuration code contrast indicator representation corresponding to the framework configuration code contrast indicator. In some embodiments, the at least one memory and the program code are configured to, with the at least one processor, cause the apparatus to output the configuration code pull request contrast interface component for rendering to the configuration code pull request operations interface.

In some embodiments, the at least one memory and the program code are configured to, with the at least one processor, cause the apparatus to generate a configuration code pull request pipeline interface component, wherein the configuration code pull request pipeline interface component comprises a framework configuration code contrast file progress indicator representation corresponding to the first framework configuration file. In some embodiments, the at least one memory and the program code are configured to, with the at least one processor, cause the apparatus to output the configuration code pull request pipeline interface component for rendering to the configuration code pull request operations interface.

In some embodiments, the framework configuration code contrast indicator representation comprises at least one of a framework configuration code contrast removal indicator representation or a framework configuration code contrast alteration indicator representation.

In some embodiments, the first framework configuration file comprises a framework configuration micro object and the at least one memory and the program code are configured to, with the at least one processor, cause the apparatus to execute a framework configuration file trimming script to remove the framework configuration micro object from the first framework configuration file.

In some embodiments, the first framework configuration file comprises a framework configuration virtual object and the at least one memory and the program code are configured to, with the at least one processor, cause the apparatus to execute a framework configuration file trimming script to remove the framework configuration virtual object from the first framework configuration file.

In some embodiments, the plurality of segmented configuration file repositories comprise a segmented production configuration file repository or a segmented staging configuration file repository.

In some embodiments, the framework configuration code pull request comprises a framework configuration alteration code and the at least one memory and the program code are configured to, with the at least one processor, cause the apparatus to receive a framework configuration code pull request consent. In some embodiments, the at least one memory and the program code are configured to, with the at least one processor, cause the apparatus to generate a revised joint framework configuration file based on the framework configuration alteration code.

In some embodiments, the at least one memory and the program code are configured to, with the at least one processor, cause the apparatus to identify a project configuration file in at least one of the plurality of segmented configuration file repositories. In some embodiments, the at least one memory and the program code are configured to, with the at least one processor, cause the apparatus to execute a project configuration file relocation script to transfer the project configuration file to a project configuration file directory in a project process repository.

In some embodiments, the project process repository comprises a project process file and the at least one memory and the program code are configured to, with the at least one processor, cause the apparatus to receive a project configuration code pull request corresponding to the project configuration file, wherein the project configuration code pull request comprises a project configuration alteration code. In some embodiments, the at least one memory and the program code are configured to, with the at least one processor, cause the apparatus to generate a revised project configuration file based on the project configuration alteration code. In some embodiments, the at least one memory and the program code are configured to, with the at least one processor, cause the apparatus to execute at least one of the project process file or the revised project configuration file. In some embodiments, the at least one memory and the program code are configured to, with the at least one processor, cause the apparatus to receive a project configuration code pull request consent. In some embodiments, the at least one memory and the program code are configured to, with the at least one processor, cause the apparatus to deploy the project process file and the revised project configuration file to a project production execution environment.

In some embodiments, the project process repository comprises a project process file and the at least one memory and the program code are configured to, with the at least one processor, cause the apparatus to receive a project process code pull request corresponding to the project process file, wherein the project process code pull request comprises a project process alteration code. In some embodiments, the at least one memory and the program code are configured to, with the at least one processor, cause the apparatus to generate a revised project process file based on the project process alteration code. In some embodiments, the at least one memory and the program code are configured to, with the at least one processor, cause the apparatus to execute at least one of the project configuration file or the revised project process file. In some embodiments, the at least one memory and the program code are configured to, with the at least one processor, cause the apparatus to receive a project process code pull request consent. In some embodiments, the at least one memory and the program code are configured to, with the at least one processor, cause the apparatus to deploy the project configuration file and the revised project process file to a project process production execution environment.

In accordance with another aspect of the present disclosure, an example method for outputting a configuration code pull request contrast interface component for rendering to a configuration code pull request operations interface is provided. In some embodiments, the method includes accessing a plurality of segmented configuration file repositories. In some embodiments, the method includes identifying a first framework configuration file in a first segmented configuration file repository of the plurality of segmented configuration file repositories and a second framework configuration file in a second segmented configuration file repository of the plurality of segmented configuration file repositories. In some embodiments, the method includes executing a framework configuration file unification script to transfer the first framework configuration file to a first framework configuration file directory in a joint framework configuration file repository and the second framework configuration file to a second framework configuration file directory in the joint framework configuration file repository. In some embodiments, the method includes receiving a framework configuration code pull request corresponding to the first framework configuration file. In some embodiments, the method includes generating a framework configuration code contrast file by applying the framework configuration code pull request and a joint framework configuration file to a framework configuration code contrast model, wherein the framework configuration code contrast file comprises a framework configuration code contrast indicator. In some embodiments, the method includes generating the configuration code pull request contrast interface component, wherein the configuration code pull request contrast interface component comprises a framework configuration code contrast indicator representation corresponding to the framework configuration code contrast indicator, wherein the framework configuration code contrast indicator representation comprises at least one of a framework configuration code contrast removal indicator representation or a framework configuration code contrast alteration indicator representation. In some embodiments, the method includes outputting the configuration code pull request contrast interface component for rendering to the configuration code pull request operations interface.

In some embodiments, the method includes generating a configuration code pull request pipeline interface component, wherein the configuration code pull request pipeline interface component comprises a framework configuration code contrast file progress indicator representation corresponding to the first framework configuration file. In some embodiments, the method includes outputting the configuration code pull request pipeline interface component for rendering to the configuration code pull request operations interface.

In some embodiments, the first framework configuration file comprises a framework configuration micro object and the method includes executing a framework configuration file trimming script to remove the framework configuration micro object from the first framework configuration file.

In some embodiments, the first framework configuration file comprises a framework configuration virtual object and the method includes executing a framework configuration file trimming script to remove the framework configuration virtual object from the first framework configuration file.

In some embodiments, the plurality of segmented configuration file repositories comprise a segmented production configuration file repository or a segmented staging configuration file repository.

In some embodiments, the framework configuration code pull request comprises a framework configuration alteration code and the method includes receiving a framework configuration code pull request consent. In some embodiments, the method includes generating a revised joint framework configuration file based on the framework configuration alteration code.

In some embodiments, the method includes identifying a project configuration file in at least one of the plurality of segmented configuration file repositories. In some embodiments, the method includes executing a project configuration file relocation script to transfer the project configuration file to a project configuration file directory in a project process repository.

In some embodiments, the project process repository comprises a project process file and the method includes receiving a project configuration code pull request corresponding to the project configuration file, wherein the project configuration code pull request comprises a project configuration alteration code. In some embodiments, the method includes generating a revised project configuration file based on the project configuration alteration code. In some embodiments, the method includes executing at least one of the project process file or the revised project configuration file. In some embodiments, the method includes receiving a project configuration code pull request consent. In some embodiments, the method includes deploying the project process file and the revised project configuration file to a project process production execution environment.

In some embodiments, the project process repository comprises a project process file and the method includes receiving a project process code pull request corresponding to the project process file, wherein the project process code pull request comprises a project process alteration code. In some embodiments, the method includes generating a revised project process file based on the project process alteration code. In some embodiments, the method includes executing at least one of the project configuration file or the revised project process file. In some embodiments, the method includes receiving a project process code pull request consent. In some embodiments, the method includes deploying the project configuration file and the revised project process file to a project process production execution environment.

In accordance with another exemplary embodiment of the present disclosure, a computer program product for outputting a configuration code pull request contrast interface component for rendering to a configuration code pull request operations interface is provided. In some embodiments, the computer program product includes at least one non-transitory computer-readable storage medium having computer-readable program code portions stored therein, the computer-readable program code portions comprising an executable portion. In some embodiments, the computer-readable program code portions comprising an executable portion are configured to access a plurality of segmented configuration file repositories, wherein the plurality of segmented configuration file repositories comprise a segmented production configuration file repository or a segmented staging configuration file repository. In some embodiments, the computer-readable program code portions comprising an executable portion are configured to identify a first framework configuration file in a first segmented configuration file repository of the plurality of segmented configuration file repositories and a second framework configuration file in a second segmented configuration file repository of the plurality of segmented configuration file repositories. In some embodiments, the computer-readable program code portions comprising an executable portion are configured to execute a framework configuration file unification script to transfer the first framework configuration file to a first framework configuration file directory in a joint framework configuration file repository and the second framework configuration file to a second framework configuration file directory in the joint framework configuration file repository. In some embodiments, the computer-readable program code portions comprising an executable portion are configured to receive a framework configuration code pull request corresponding to the first framework configuration file. In some embodiments, the computer-readable program code portions comprising an executable portion are configured to generate a framework configuration code contrast file by applying the framework configuration code pull request and a joint framework configuration file to a framework configuration code contrast model, wherein the framework configuration code contrast file comprises a framework configuration code contrast indicator. In some embodiments, the computer-readable program code portions comprising an executable portion are configured to generate the configuration code pull request contrast interface component, wherein the configuration code pull request contrast interface component comprises a framework configuration code contrast indicator representation corresponding to the framework configuration code contrast indicator. In some embodiments, the computer-readable program code portions comprising an executable portion are configured to output the configuration code pull request contrast interface component for rendering to the configuration code pull request operations interface.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example software development operations system configured to communicate with various client devices in accordance with various example embodiments of the present disclosure;

FIG. 2 depicts a schematic block diagram of example circuitry to perform various operations in accordance with various example embodiments of the present disclosure;

FIG. 3 illustrates a configuration code pull request operations interface in accordance with various example embodiments of the present disclosure;

FIG. 4 illustrates the configuration code pull request operations interface in accordance with various example embodiments of the present disclosure;

FIG. 5 illustrates a configuration code pull request operations interface in accordance with various example embodiments of the present disclosure;

FIG. 6 depicts a flowchart diagram illustrating an example method in accordance with an example embodiment of the present disclosure;

FIG. 7 depicts a flowchart diagram illustrating an example method in accordance with an example embodiment of the present disclosure; and

FIG. 8 depicts a flowchart diagram illustrating an example method in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to enable efficient, reliable, dynamic, and secure management of software development related configuration files, such as framework configuration files and project configuration files, software development related project process files, and various interface components used in software development operations environments. The embodiments address technical challenges related to effectively organizing, updating, and deploying configuration files and project process files across multiple repositories and environments.

Software development operations systems enable enterprises to plan, track, organize, execute, and monitor software applications and software development projects. These systems often need to manage complex configuration settings across multiple applications and environments. However, many existing systems struggle to efficiently handle framework configuration files that define shared settings across multiple applications, as well as project-specific configuration files that are unique to a particular software applications. This can lead to inconsistencies, errors, and inefficiencies when performing pull requests and deploying configuration to various distributed execution environments.

Traditional approaches often rely on maintaining separate configuration files for each software application and execution environment. This can result in duplication of common configurations, making it difficult to propagate changes through a software development operations system and across various distributed and/or different software applications. Additionally, traditional approaches for reviewing and validating configuration changes use resource intensive and simplistic computing comparison techniques, which is time-consuming and error prone. Deploying updated configurations to the appropriate environments also presents challenges, as it requires careful coordination between numerous software development operations components to ensure the correct files are applied to the right locations.

The embodiments of the present disclosure address these technical challenges by providing a unified, streamlined, and automated approach to managing framework configuration files. A framework configuration file unification script is utilized to consolidate framework configuration files from multiple segmented repositories into a centralized joint framework configuration file repository. This enables more efficient management of shared configurations across software application applications. Further, a framework configuration file trimming script is utilized to remove framework configuration micro objects and framework configuration virtual objects from framework configuration files that are redundant in a joint framework configuration file repository.

The embodiments of the present disclosure address these technical challenges by generating a configuration code pull request contrast interface component to visually represent proposed changes to framework configuration files. This allows for effective validation of the framework configuration file unification script, the framework configuration file trimming script, and framework configuration code pull requests. Additionally, the system provides a configuration code pull request pipeline interface component to track the progress of framework configuration code pull requests through various stages of implementation and deployment.

The embodiments of the present disclosure address these technical challenges by implementing a project configuration file relocation script, which enables more streamlined management of project-specific configurations alongside their associated process files. This improves organization, reduces the likelihood of mismatched project configuration files and project process files, enables easier identification of code errors, and decreases processing consumption during execution of a software application. Further, automated deployment of framework configuration files, project configuration files, and project process files to the appropriate execution environments, enhances reliability and efficiency in the software development process.

These technical solutions enable software development operations systems to more effectively manage complex configuration scenarios, improving consistency, reducing errors, improving delivery speed of code updates, reducing incident response time and streamlining the process of updating and deploying software configurations across multiple applications and environments.

### Definitions

The following explanations of terms are provided to better describe the present disclosure and to guide those of ordinary skill in the art in the practice of the present disclosure.

In some embodiments, the term “software development operations system” refers to software platform(s) and associated hardware configured to support and maintain a plurality of projects, workflows, and all associated functionality. For example, a software development operations system may comprise a software product such as Jira® by Atlassian® or Opsgenie® by Atlassian®. Example software development operations systems comprise supporting server(s) and repositor(ies), and in some embodiments, are further configured to engage with internal resources, external resources, internal applications, and/or external applications.

In some embodiments, the term “software development operations server” refers to is a software platform and associated hardware that is configured to, inter alia, manage the various interfaces and/or interface components and associated functionality of the software development operations system. For example, in some embodiments, the software development operations server is configured to generate, manage, output, and/or update configuration code pull request contrast interface components, configuration code pull request pipeline interface components, and/or the like.

As another example, in some embodiments, the software development operations server is configured to execute, extract, relocate, implement, receive, generate, and/or output framework configuration file unification scripts, framework configuration file trimming scripts, project configuration file relocation scripts, and/or the like. As another example, in some embodiments, the software development operations server is configured to execute, extract, relocate, implement, receive, generate, and/or output project process code pull requests, revised project process files, project configuration code pull requests, revised project configuration files, project configuration files, revised joint framework configuration files, project configuration files, framework configuration files, and/or the like.

In some embodiments, the term “software development operations application” refers to a dedicated software program, application, platform, service, web browser, or computer-executable application software programmed or configured to run on a client device which provides a user access to the software development operations system and its associated functionality. In some embodiments, the software development operations application may include hardware, software, or combinations thereof operating remotely (e.g., on a server). In some embodiments, the software development operations application is designed to execute on mobile devices, such as tablets or smartphones. For example, in certain embodiments, an application is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

In some embodiments, the term “software application” refers to a computing application that implements, runs, executes, and/or the like one or more project process files, project configuration files, and/or program configuration files in order to perform one or more functions for an end user.

In some embodiments, the term “framework configuration file” refers to a computing file that defines settings, parameters, and/or configurations common to multiple software applications within a software application ecosystem. A framework configuration file serves as a centralized repository of shared settings, parameters, and/or configurations shared between multiple software applications, enabling consistent application behavior across different software applications.

The technical implementation of a framework configuration file may comprise structured data formats such as JSON, YAML, and/or XML. These formats allow for hierarchical organization of settings, parameters, and/or configurations. A framework configuration file may be stored in a version control system like Git, enabling tracking of changes over time.

A framework configuration file may be processed by software applications, configuration management tools, and/or custom scripts that parse settings, parameters, and/or configurations of a framework configuration file and/or apply settings, parameters, and/or configurations to the appropriate components of a software application. The parsed settings, parameters, and/or configurations may then be loaded into memory structures and/or databases for efficient access by a software application during runtime.

A framework configuration file defines settings, parameters, and/or configurations that comprise one or more of framework configuration micro objects, virtual objects, geographic configurations, and/or data privacy settings. These settings, parameters, and/or configurations may define one or more of database connection parameters, API endpoints, logging levels, feature flags, and/or environment-specific variables for a software application. Framework configuration files play a crucial role in maintaining consistency across different environments (e.g., development, staging, production) and/or facilitating the deployment process. They allow for easy modification of system-wide settings without requiring changes to individual software applications.

In some embodiments, the term “project configuration file” refers to a computing file that defines settings, parameters, and/or configurations specific to a particular software application within a software ecosystem. A project configuration file comprises settings, parameters, and/or configurations for a software application to perform its intended functions, tailored to the unique requirements of the software application.

The technical implementation of a project configuration file may comprise using structured data formats such as JSON, YAML, and/or XML. These formats allow for clear organization and/or easy parsing of settings, parameters, and/or configurations. Project configuration files may be stored alongside a project process file in version control systems, enabling tracking of configuration changes in conjunction with code changes.

A project configuration file may be processed by software applications, configuration management tools, and/or custom scripts that parse settings, parameters, and/or configurations of a project configuration file and/or apply settings, parameters, and/or configurations to the appropriate components of a software application. The parsed settings, parameters, and/or configurations may then be loaded into memory structures and/or databases for efficient access by a software application during runtime.

A project configuration file comprises software application-specific settings, parameters, and/or configurations, such as one or more of database connection strings, API keys, feature toggles, logging configurations, environment-specific variables, references to external resources, service endpoints, and/or integration configurations. The file structure often reflects the application's architecture, with sections dedicated to different components and/or modules of the application.

Security considerations for project configuration files comprise encryption of sensitive data (such as API keys and/or passwords), access control to restrict computing devices that can view and/or modify project configuration files, and/or auditing mechanisms to track changes. Additionally, validation schemas may be implemented to ensure the integrity and/or correctness of a project configuration file before it is applied to the application.

In some embodiments, the term “project process file” refers to a computing file that contains code and/or instructions designed to perform one or more specific computing functions within a software development project. A project process file serves as a fundamental building block of a software application, encapsulating the logic and/or operations to execute particular tasks and/or workflows associated with a software application.

The technical implementation of a project process file varies depending on the programming language and/or framework used in a software application. A project process file may be a source code file written in languages such as Java, Python, JavaScript, C++, and/or any other programming language relevant to the project process file. The source code files may follow the syntax and/or structure specific to their language, and/or may include class definitions, function declarations, control structures, and/or other programming constructs. Project process files may be compiled and/or interpreted, depending on the language and/or runtime environment. In compiled languages, project process files undergo a compilation step to generate executable code, while interpreted languages may execute the code directly and/or through a just-in-time compilation process.

A project process file may comprise the implementation of specific features, algorithms, and/or business logic required by the software application. This comprises one or more of data processing routines, API integrations, user interface components, database operations, and/or any other functionality. Project process files interact with project configuration files and/or framework configuration files by reading settings, parameters, and/or configurations to adjust their behavior based on the current environment and/or user-defined options.

In some embodiments, the term “joint framework configuration file” refers to a computing file that comprises multiple framework configuration files in a single, comprehensive configuration resource for software applications. In this regard, a joint framework configuration file serves as a consolidated collection of settings, parameters, and/or configurations that are shared across various software applications.

A technical implementation of a joint framework configuration file comprises a process of merging and/or aggregating individual framework configuration files through implementation of a framework configuration file unification script. A joint framework configuration file may be stored in a structured format such as JSON, YAML, and/or XML, which allows for hierarchical organization of the settings, parameters, and/or configurations in the joint framework configuration file.

In some embodiments, the term “framework configuration micro object” refers to a setting, parameter, and/or configuration that defines a microenvironment in which one or more software applications operate, run, and/or are executed. A framework configuration micro object represents a granular unit of configuration that pertains to the specific operational context and/or runtime environment of a software application within a larger software ecosystem (e.g., a larger software ecosystem comprising multiple microenvironments).

Implementation of a framework configuration micro object comprises using one or more technologies and/or approaches. For example, in a microservices architecture, a framework configuration micro object may be defined using service mesh configurations like Istio and/or Linkerd, specifying details such as service discovery, load balancing, and/or circuit breaking parameters. As another example, in a container-based environment, a framework configuration micro object may be part of Kubernetes ConfigMaps and/or Secrets, defining environment-specific variables and/or runtime parameters for containerized applications.

In some embodiments, the term “framework configuration virtual object” refers to a setting, parameter, and/or configuration that defines a virtual private cloud (VPC) in which one or more software applications operate, run, and/or are executed. A framework configuration virtual object encapsulates settings, parameters, and/or configurations that may be used to establish and/or manage a virtualized network environment for deployment and/or execution of a software application.

Implementation of a framework configuration virtual object comprises defining a set of network and/or infrastructure settings, parameters, and/or configurations that describe the characteristics of a virtual private cloud. The settings, parameters, and/or configurations may be represented as a structured data object, such as in a JSON, YAML, and/or XML format, which can be processed by cloud management tools and/or infrastructure-as-code platforms.

In some embodiments, the term “segmented configuration file repository” refers to a database, repository, and/or storage system in which a framework configuration file is stored prior to the execution of a framework configuration file unification script and/or in which a project configuration file is stored prior to the execution of a project configuration file relocation script. In some embodiments, a software development operations system may interact with a plurality of segmented configuration file repositories. For example, a first framework configuration file may be stored in a first segmented configuration file repository of a plurality of segmented configuration file repositories and a second framework configuration file may be stored in a second segmented configuration file repository of a plurality of segmented configuration file repositories. In some embodiments, a plurality of segmented configuration file repositories may comprise segmented configuration file repositories associated with different geographic regions and/or the like. Said differently, for example, each framework configuration file repository of a plurality of framework configuration file repositories may comprises framework configuration files that are slightly different based on the geographic region associated with the particular framework configuration file.

A segmented configuration file repository may comprise metadata associated with a framework configuration file and/or a project configuration file, such as version information, last modified timestamps, and/or author details. In some embodiments, a segmented configuration file repository leverages containerization technologies like Docker to create isolated environments for different framework configuration files and/or project configuration files. For example, a first segmented configuration file repository may be a first Docker image and comprise a first framework configuration file and a second segmented configuration file repository may be a second Docker image and comprise a second framework configuration file.

In some embodiments, the term “segmented production configuration file repository” refers to a specific type of segmented configuration file repository that is associated with a configuration production execution environment. This repository serves as a dedicated storage system for maintaining production-level framework configuration files and/or production-level project configuration files across different segments of a software development ecosystem prior to execution of a framework configuration file unification script. A segmented production configuration file repository may comprise a structured organization of framework configuration files and/or project configuration files that may be segmented by geographic region, data center, and/or specific production environment (e.g., prod-oregon, prod-eu, prod-ap). A segmented production configuration file repository may store configurations in formats optimized for quick parsing and/or application in production environments, such as minimized JSON and/or binary formats. A segmented production configuration file repository may also maintain strict versioning and/or change history to facilitate quick rollbacks in case of issues. In some implementations, a segmented production configuration file repository implements automated backup and/or disaster recovery techniques to ensure the integrity and/or availability of critical settings, parameters, and/or configurations. They may also implement real-time monitoring and/or alerting systems to detect and/or respond to any unauthorized changes and/or anomalies in settings, parameters, and/or configurations.

In some embodiments, the term “segmented staging configuration file repository” refers to a specific type of segmented configuration file repository that is associated with a configuration staging execution environment. This repository serves as a dedicated storage system for maintaining staging-level framework configuration files and/or staging-level project configuration files across different segments of a software development ecosystem prior to execution of a framework configuration file unification script. In cloud-based environments, a segmented staging configuration file repository may be implemented using services that provide staging-specific features for creating separate staging stacks and/or for managing staging-specific resource groups. These services allow for the creation and/or management of isolated staging environments that closely resemble production environments.

In some embodiments, the term “framework configuration file directory” refers to a memory location within a joint framework configuration file repository where framework configuration files are stored. Said differently, for example, framework configuration file directory serves as a specific storage area for a framework configuration file of a set of unified framework configuration files after a framework configuration file unification script has been executed. In some implementations, a framework configuration file directory implements symbolic linking and/or aliasing to manage complex configuration relationships with other framework configuration file directories without duplication.

In some embodiments, the term “joint framework configuration file repository” refers to a database, repository, and/or storage system in which joint framework configuration files are stored. This repository serves as a centralized location for maintaining consolidated framework configuration files that have been unified from multiple segmented configuration sources using a framework configuration file unification script. Said differently, for example, a joint framework configuration file repository may comprise a database, repository, and/or storage system in which one or more framework configuration files are stored after execution of a framework configuration file unification script. A joint framework configuration file repository comprises one or more framework configuration file directories (e.g., a first framework configuration file directory). In some embodiments, a joint framework configuration file repository is associated with a configuration production execution environment and/or a configuration staging execution environment.

In cloud-native environments, a joint framework configuration file repository may be implemented using one or more cloud-based managed services. These cloud-based managed services provide features like versioning, encryption, and/or fine-grained access control specifically designed for managing framework configurations at scale. A joint framework configuration file repositories is configured to at least partially maintain a single source of truth for system-wide configurations (e.g., framework configuration files) by facilitating the management of complex, interdependent settings, parameters, and/or configurations across multiple software applications. By centralizing settings, parameters, and/or configurations, a joint framework configuration file repository enables improved auditing, versioning, and/or rollback of setting, parameter, and/or configuration changes, which improves system stability and/or compliance.

In some implementations, a joint framework configuration file repository may integrate with CI/CD pipelines to automatically generate, validate, and/or deploy settings, parameters, and/or configurations, such as by running automated tests against new settings, parameters, and/or configurations, performing impact analysis of setting, parameter, and/or configuration changes, and/or orchestrating the rollout of updated settings, parameters, and/or configurations across multiple software applications. In some embodiments, a joint framework configuration file repository incorporates machine learning algorithms to analyze setting, parameter, and/or configuration patterns, detect anomalies, and/or suggest optimizations. This may enable dynamic setting, parameter, and/or configuration updates, allowing certain setting, parameter, and/or configuration changes to be applied to running software applications without requiring restarts and/or redeployments.

In some embodiments, the term “project process repository” refers to a database, repository, and/or storage system in which a project process file is stored and/or a database, repository, and/or storage system in which a project configuration file is stored after execution of a project configuration file relocation script. In this regard, for example, a project process repository serves as a centralized location for maintaining the core operational code and/or associated project configuration files for a specific software application. In some embodiments, a project process repository comprises one or more project configuration file directories.

A project process repository, in some implementations, comprises, a structured organization of directories and/or files that represent source code files, build scripts, documentation, and/or project configuration files associated with a particular software application. In some implementations, by combining a project process file and an associated project configuration file into a project process repository, fewer pull requests are required to update a particular software application, which results in reduce processing expenditure and memory consumption.

In some embodiments, the term “project configuration file directory” refers to a memory location within a project process repository where project configuration files are stored after the execution of a project configuration file relocation script. Said differently, for example, a project configuration file directory serves as a dedicated storage location for a project configuration file within a project process repository. In some implementations, a project configuration file directory implements symbolic linking and/or aliasing to manage complex configuration relationships with other project configuration file directories without duplication.

In some embodiments, the term “project production execution environment” refers to a production computing environment in which project process files and/or revised project configuration files are deployed, implemented, and/or executed. This environment represents the live, operational setting in which project process files and/or revised project configuration files are deployed, implemented, and/or executed such that software applications may interact with end-users and/or perform their intended functions at scale.

In some embodiments, the term “project staging execution environment” refers to a staging computing environment in which project process files and/or revised project configuration files are deployed and/or tested before being moved to production. This environment serves as a final testing ground that closely mimics the production environment, allowing for thorough validation of software changes without impacting live systems.

In some embodiments, the term “configuration production execution environment” refers to a production computing environment in which framework configuration files and/or revised joint framework configuration files are deployed, implemented, and/or executed. This environment represents the live, operational setting in which framework configuration files and/or revised joint framework configuration files are deployed, implemented, and/or executed such that software applications may interact with end-users and/or perform their intended functions at scale.

In some embodiments, the term “configuration staging execution environment” refers to a staging computing environment in which framework configuration files and/or revised joint framework configuration files are deployed and/or tested before being applied to the production environment. This environment serves as a controlled testing ground for configuration changes, allowing for thorough validation without risking the stability of live systems.

In some embodiments, the term “framework configuration file unification script” refers to a computing script performed to transfer framework configuration files from a segmented configuration file repository to a particular framework configuration file directory in a joint framework configuration file repository. This script serves as an automated mechanism for consolidating disparate configuration files into a centralized, unified structure.

In some implementations, a technical implementation of a framework configuration file unification script comprises implementing a program and/or script using languages such as Python, Bash, and/or PowerShell, depending on the operating environment and/or integration requirements. The script may utilize file system operations for reading and/or writing files, and/or may incorporate libraries for parsing various configuration file formats such as JSON, YAML, and/or XML. In more complex implementations, the script might leverage version control system APIs (e.g., Git APIs) to interact with repositories programmatically.

A framework configuration file unification script may incorporate logic for handling conflicts and/or merging configurations from different sources. This may involve implementing merge strategies, such as overwriting, appending, and/or using more sophisticated algorithms for combining configuration values. The script may also include error handling and/or logging mechanisms to ensure robustness and/or provide an audit trail of the unification process.

In some embodiments, the term “framework configuration file trimming script” refers to a computing script performed to remove one or more settings, parameters, and/or configurations from a framework configuration file. A framework configuration file trimming script serves as an automated tool for refining and/or optimizing framework configuration files by eliminating settings parameters, and/or configurations that are not necessary in a joint framework configuration file.

In some implementations, a technical implementation of a framework configuration file trimming script comprises implementing a program using scripting languages such as Python, Ruby, and/or JavaScript, and/or compiled languages like Java and/or C. Regular expressions and/or specialized text processing libraries may be employed for more intricate pattern matching and/or removal operations.

In some implementations, a framework configuration file trimming script comprises logic for identifying and/or removing settings, parameters, and/or configurations from a framework configuration file based on predefined rules and/or patterns. This may involve implementing algorithms to traverse nested settings, parameters, and/or configurations, compare values against a set of criteria, and/or selectively remove and/or modify settings, parameters, and/or configurations. A framework configuration file trimming script may comprise predefined safeguard rules to prevent the removal of critical settings, parameters, and/or configurations. This may be done by maintaining a list of protected keys and/or values.

In some embodiments, the term “project configuration file relocation script” refers to a computing script performed to transfer a project configuration file from a segmented configuration file repository to a project configuration file directory. This script serves as an automated mechanism for reorganizing and/or centralizing project-specific configurations within the project's own repository and/or directory structure.

In some implementations, a project configuration file relocation script comprises a program using scripting languages such as Python, Bash, and/or PowerShell, depending on the operating environment and/or integration requirements. The script may utilize file system operations for reading, writing, and/or moving files, and/or may incorporate version control system APIs for interacting with repositories programmatically. In cloud-based environments, the script might leverage cloud provider SDKs and/or APIs to interact with cloud storage services and/or software applications. A project configuration file relocation script may comprise logic for handling file path transformations, ensuring that references within a project configuration file are updated to reflect the new location of the project configuration file.

In some embodiments, the term “framework configuration code pull request” refers to a pull request (PR) that comprises a request to make one or more changes to a framework configuration file of a joint framework configuration file. A framework configuration code pull request serves as a mechanism for proposing, reviewing, and/or integrating modifications to system-wide configuration settings (e.g., settings, parameters, and/or configurations in a joint framework configuration file) in a controlled and/or collaborative manner. A framework configuration code pull request comprises information about the proposed changes that comprise one or more of framework configuration alteration code, metadata about the requester, reviewers, and/or the current status of the request. A framework configuration code pull request may be received by a software development operations system after the software development operations system has performed a framework configuration file unification script.

In some embodiments, the term “framework configuration alteration code” refers to code, text, and/or other content that comprises one or more alterations to, changes to, deletions to, and/or the like of the computing code, text, and/or the like in a framework configuration file of a joint framework configuration file. A framework configuration alteration code represents the specific modifications proposed to be made to the settings, parameters, and/or configurations of a framework configuration file of a joint framework configuration file. In some implementations, a technical implementation of framework configuration alteration code comprises representing the changes in a format that can be easily parsed. This may comprise using diff formats for text-based configurations, and/or specialized data structures for more complex configuration types. A framework configuration alteration code, in some implementations, comprises metadata and/or annotations to provide context for the changes. For example, the metadata and/or annotations comprise comments explaining the rationale behind the modifications, references to related issues and/or tickets, and/or tags indicating the scope and/or impact of the changes.

In some embodiments, the term “framework configuration code contrast file” refers to a file that comprises code, text, and/or other content that is indicative of and/or associated with one or more alterations to, changes to, deletions to, and/or the like of the computing code, text, and/or the like in a framework configuration file of a joint framework configuration file suggested, proposed, and/or requested by a framework configuration code pull request. This contrast file serves as a comprehensive representation of the differences between the current configuration and/or the proposed changes. In this regard, a framework configuration code contrast file comprises one or more framework configuration contrast indicators.

In some embodiments, the term “framework configuration code contrast indicator” refers to one or more items of data indicative of an alteration to, change to, deletion from, and/or the like of the computing code, text, and/or the like in a framework configuration file of a joint framework configuration file suggested, proposed, and/or requested by a framework configuration code pull request. Said differently, for example, a framework configuration code contrast indicator is a specific data marker and/or signal that identifies a particular change, alteration, and/or deletion represented in a framework configuration code contrast file.

A framework configuration code contrast indicator enables sophisticated analysis of a framework configuration code contrast file by providing precise, granular information about proposed alterations, changes, and/or deletions. They enable reviewers to quickly identify and/or focus on specific modifications, facilitate automated analysis and/or validation of changes, and/or serve as building blocks for more complex change visualization and/or management tools. In some implementations, implementation of framework configuration code contrast indicators comprises integration with AI-driven analysis tools to predict the impact of changes, automated generation of test cases based on the nature of the indicated changes, and/or dynamic, interactive visualizations that allow users to explore the implications of configuration modifications in real-time.

In some embodiments, the term “framework configuration code contrast removal indicator” refers to a specific type of a framework configuration code contrast indicator that comprises one or more items of data indicative of computing code, text, and/or the like in a framework configuration file of a joint framework configuration file that a framework configuration code pull request is proposing, suggesting, and/or requesting to remove from the framework configuration file of the joint framework configuration file. This indicator specifically highlights elements that are slated for deletion by a framework configuration code pull request.

A framework configuration code contrast removal indicator may comprise additional metadata to provide context for the proposed deletions. This might include information about dependencies that might be affected by the removal, historical usage data associated with the computing code, text, and/or the like being removed, and/or references to documentation explaining the rationale behind the deletion. For example, a framework configuration code contrast removal indicator may be linked to impact analysis tools that can predict the consequences of removing the computing code, text, and/or the like.

In some embodiments, the term “framework configuration code contrast addition indicator” refers to a specific type of a framework configuration code contrast indicator that comprises one or more items of data indicative of computing code, text, and/or the like in a framework configuration file of a joint framework configuration file that a framework configuration code pull request is proposing, suggesting, and/or requesting to add to the framework configuration file of the joint framework configuration file. This indicator specifically highlights elements that are slated for addition by a framework configuration code pull request.

A framework configuration code contrast addition indicator may comprise additional metadata to provide context for the proposed addition. This might include information about dependencies that might be affected by the addition, historical usage data associated with the computing code, text, and/or the like being added, and/or references to documentation explaining the rationale behind the addition. For example, a framework configuration code contrast addition indicator may be linked to impact analysis tools that can predict the consequences of adding the computing code, text, and/or the like.

In some embodiments, the term “framework configuration code contrast alteration indicator” refers to a specific type of a framework configuration code contrast indicator that comprises one or more items of data indicative of computing code, text, and/or the like in a framework configuration file of a joint framework configuration file that a framework configuration code pull request is proposing, suggesting, and/or requesting to change and/or alter. This indicator specifically highlights elements that are being modified by a framework configuration code pull request.

A framework configuration code contrast alteration indicators may comprise contextual information about the proposed changes. The contextual information may comprise one or more of significant and/or potential impact of the changes based on a machine learning model based classification and/or analysis, insights based on historical data related to similar past modifications, potential ripple effects based on an analysis performed using integrated system architecture models, and/or suggestions for related changes and/or optimizations based on the framework configuration code pull request.

In some embodiments, the term “framework configuration code contrast model” refers to hardware and/or software comprising parameters, hyper-parameters, and/or defined operations of a rules-based, machine learning model, and/or generative artificial intelligence model configured to be used to generate a framework configuration code contrast file based on a framework configuration code pull request and/or a joint framework configuration file.

A technical implementation of a framework configuration code contrast model comprises a combination of traditional software engineering techniques and/or advanced machine learning and/or AI methodologies. For example, the framework configuration code contrast model may be implemented using deep learning frameworks such as TensorFlow and/or PyTorch for neural network-based approaches, and/or libraries like scikit-learn for more traditional machine learning algorithms. For rule-based components, expert systems and/or decision tree frameworks might be employed. The model architecture often includes multiple layers and/or components, each specialized for different aspects of configuration analysis and/or contrast generation.

In some embodiments, the term “framework configuration code contrast indicator representation” refers to a visual representation of a framework configuration code contrast indicator that is configured to be displayed on a configuration code pull request contrast interface component. This representation serves as a graphical and/or textual element that visually communicates the nature and/or details of a specific framework configuration code contrast indicator.

A framework configuration code contrast indicator representation may be implemented using color coding, iconography, and/or interactive elements to effectively communicate different types of changes. For instance, additions might be represented in green, deletions in red, and/or modifications in yellow. The representations might also include expandable sections to reveal more detailed information about the change, tooltips to provide context and/or explanations, and/or links to related documentation and/or code sections. In some implementations, a framework configuration code contrast indicator representation is adapted based on user preferences and/or roles, showing different levels of detail and/or focusing on specific aspects of the change depending on the viewer's needs.

In some embodiments, the term “framework configuration code contrast removal indicator representation” refers to a specific type of a framework configuration code contrast indicator representation that comprises a visual representation of a framework configuration code contrast removal indicator that is configured to be displayed on a configuration code pull request contrast interface component. This representation specifically visualizes elements of a configuration file that are proposed to be removed as part of a configuration change.

A framework configuration code contrast removal indicator representation may comprise distinct visual cues to clearly highlight removals. For example, by using red text and/or background, strikethrough formatting, and/or specific icons (like a minus sign and/or trash can) to denote removed elements. The representations might also incorporate animations and/or transitions to visually demonstrate the “removal” effect, helping users understand the before and/or after states of the removal. In some implementations, a framework configuration code contrast removal indicator representation comprises contextual information, such as showing dependencies that might be affected by the removal and/or providing historical usage data of the element being removed.

In some embodiments, the term “framework configuration code contrast addition indicator representation” refers to a specific type of a framework configuration code contrast indicator representation that comprises a visual representation of a framework configuration code contrast addition indicator that is configured to be displayed on a configuration code pull request contrast interface component. This representation specifically visualizes elements of a configuration file that are proposed to be added as part of a configuration change.

A framework configuration code contrast addition indicator representation may comprise distinct visual cues to clearly highlight additions. For example, by using green text and/or background, underline formatting, and/or specific icons (like a plus sign) to denote added elements. The representations might also incorporate animations and/or transitions to visually demonstrate the “addition” effect, helping users understand the before and/or after states of the addition. In some implementations, a framework configuration code contrast addition indicator representation comprises contextual information, such as showing dependencies that might be affected by the addition and/or providing historical usage data of the element being added.

In some embodiments, the term “framework configuration code contrast alteration indicator representation” refers to a specific type of a framework configuration code contrast indicator representation that comprises a visual representation of a framework configuration code contrast alteration indicator that is configured to be displayed on a configuration code pull request contrast interface component. This representation specifically visualizes elements of a configuration file that are proposed to be modified and/or changed as part of a framework configuration code pull request.

A framework configuration code contrast alteration indicator representation may be implemented using visual techniques to effectively communicate the nature and/or extent of changes. For example, a framework configuration code contrast alteration indicator comprises color coding (e.g., yellow highlighting) to show modified elements, side-by-side and/or inline diff views to compare original and/or modified values, and/or interactive elements that allow users to toggle between different views of the change. A framework configuration code contrast alteration indicator representation may comprise visual cues to indicate the type of change (e.g., value change, type change, structural change) and/or its potential impact. In some implementations, a framework configuration code contrast alteration indicator representation is adaptable based on the complexity of the change, providing summarized views for minor alterations and/or more detailed, expandable views for significant modifications.

In some embodiments, the term “configuration code pull request operations interface” refers to a graphical user interface of a software development operations system that is configured to enable one or more users to view and engage with one or more software development operations workspaces, views, and/or interface components. In some embodiments, for example, a configuration code pull request operations interface is configured to enable one or more users to view and engage with one or more program configuration code pull request contrast interface components, configuration code pull request pipeline interface components, and/or the like. In some embodiments, a configuration code pull request operations interface may be rendered to a client device based on data provided by or to a software development operations system. In some embodiments, such data and instructions are facilitated by a dedicated software application running on the client device. In other embodiments, such data and instructions are provided through a web browser running on the client device.

In some embodiments, the term “configuration code pull request contrast interface component” refers to an interface component that may be output for rendering to a configuration code pull request operations interface. A configuration code pull request contrast interface component comprises one or more framework configuration code contrast removal indicator representations, framework configuration code contrast addition indicator representations, and/or framework configuration code contrast alteration indicator representations.

In some embodiments, the term “framework configuration code contrast file progress indicator” refers to one or more items of data indicative of a real-time progress and/or status of the generation of a framework configuration code contrast file. For example, a framework configuration code contrast file progress indicator is configured to provide dynamic feedback on the process of creating a comprehensive representation of changes requested, suggested, and/or proposed by a framework configuration code pull request.

A technical implementation of a framework configuration code contrast file progress indicator comprises real-time data processing and/or event-driven programming techniques. This might include using websockets and/or server-sent events (SSE) for real-time communication between the software development operations system generating the contrast file and/or the client displaying the progress. The software development operations system may be configured to employ multi-threading and/or asynchronous processing to handle the generation of the contrast file while simultaneously updating the framework configuration code contrast file progress indicator.

In some implementations, a framework configuration code contrast file progress indicator comprises metrics that indicate the percentage of completion, the current stage of processing (e.g., parsing files, comparing changes, generating diff), and/or estimated time remaining in the generation of a framework configuration code contrast file. Additionally, or alternatively, a framework configuration code contrast file progress indicator provides granular information about specific parts of a framework configuration code contrast file being generated, such as progress on different framework configuration files and/or types of changes being processed. Additionally, or alternatively, a framework configuration code contrast file progress indicator comprises status information like success, warnings, and/or errors encountered during the generation process of a framework configuration code contrast file.

In some embodiments, the term “framework configuration code contrast file progress indicator representation” refers to a visual representation of a framework configuration code contrast file progress indicator that is configured to be displayed on a configuration code pull request pipeline interface component. A framework configuration code contrast file progress indicator representation provides a graphical and/or textual visualization of the real-time progress in generating a framework configuration code contrast file.

In some implementations, a framework configuration code contrast file progress indicator representation comprises progress bars, percentage counters, animated icons, radial progress charts, step-based progress indicators, and/or color coding to indicate different statuses (e.g., green for completed, yellow for in progress, red for errors). Additionally, or alternatively, a framework configuration code contrast file progress indicator representation comprises interactive elements that allow users to drill down into specific aspects of the progress, such as expanding to see detailed status for different parts of the framework configuration code contrast file being generated.

In some embodiments, the term “configuration code pull request pipeline interface component” refers to an interface component that may be output for rendering to a configuration code pull request operations interface. A configuration code pull request pipeline interface component comprises one or more framework configuration code contrast file progress indicator representations.

In some embodiments, the term “framework configuration code pull request consent” refers to one or more items of data representative of an approval of a framework configuration code pull request. A framework configuration code pull request consent serves as a formal acknowledgment and/or authorization for proposed changes to a framework configuration file. A technical implementation of a framework configuration code pull request consent may comprise data structures and/or processing algorithms designed to capture, store, and/or validate approval information. This might include using digital signature technologies to ensure the authenticity and/or non-repudiation of the framework configuration code pull request consent, such as public key infrastructure (PKI) for cryptographic signing. The framework configuration code pull request consent might be stored in secure databases, potentially using blockchain technology for an immutable audit trail of approvals.

In some embodiments, the term “revised joint framework configuration file” refers to a revised version of a joint framework configuration file that is updated based on a framework configuration code pull request and/or in response to receiving a framework configuration code pull request consent.

In some embodiments, the term “project configuration code pull request” refers to a pull request (PR) that comprises a request to make one or more changes to a project configuration file. A project configuration code pull request serves as a mechanism for proposing, reviewing, and/or integrating modifications to configuration settings (e.g., settings, parameters, and/or configurations in a project configuration file) in a controlled and/or collaborative manner. A project configuration code pull request comprises information about the proposed changes that comprise one or more of project configuration alteration code, metadata about the requester, reviewers, and/or the current status of the request. A framework configuration code pull request may be received by a software development operations system after the software development operations system has performed a project configuration file relocation script.

In some embodiments, the term “project configuration alteration code” refers to code, text, and/or other content that comprises one or more alterations to, changes to, deletions to, and/or the like of the computing code, text, and/or the like in a project configuration file. A project configuration alteration code represents the specific modifications proposed to be made to the settings, parameters, and/or configurations of a project configuration file. In some implementations, a technical implementation of project configuration alteration code comprises representing the changes in a format that can be easily parsed. This may comprise using diff formats for text-based configurations, and/or specialized data structures for more complex configuration types. A project configuration alteration code, in some implementations, comprises metadata and/or annotations to provide context for the changes. For example, the metadata and/or annotations comprise comments explaining the rationale behind the modifications, references to related issues and/or tickets, and/or tags indicating the scope and/or impact of the changes.

In some embodiments, the term “project configuration code pull request consent” refers to one or more items of data representative of an approval of a project configuration code pull request. A project configuration code pull request consent serves as a formal acknowledgment and/or authorization for proposed changes to a project configuration file. The technical implementation of a project configuration code pull request consent comprises data structures and/or processing algorithms designed to capture, store, and/or validate approval information. This might include using digital signature technologies to ensure the authenticity and/or non-repudiation of the project configuration code pull request consent, such as public key infrastructure (PKI) for cryptographic signing. The project configuration code pull request consent might be stored in secure databases, potentially using blockchain technology for an immutable audit trail of approvals.

In some embodiments, the term “revised project configuration file” refers to a revised version of a project configuration file that is updated and/or generated based on a project configuration code pull request and/or in response to receiving a project configuration code pull request consent.

In some embodiments, the term “project process code pull request” refers to a pull request (PR) that comprises a request to make one or more changes to a project process file (e.g., the core operational code of a specific software application). A project process code pull request serves as a mechanism for proposing, reviewing, and/or integrating modifications to a project process file in a controlled and/or collaborative manner. A project process code pull request comprises information about the proposed changes that comprise one or more of project process alteration code, metadata about the requester, reviewers, and/or the current status of the request. A project process code pull request may be received by a software development operations system after the software development operations system has performed a project configuration file relocation script.

In some embodiments, the term “project process alteration code” refers to code, text, and/or other content that comprises one or more alterations to, changes to, deletions to, and/or the like of the computing code, text, and/or the like in a project process file. Project process alteration code represents the specific modifications proposed to be made to the code, text, and/or information of a project process file. In some implementations, a technical implementation of project process alteration code comprises representing the changes in a format that can be easily parsed. This may comprise using diff formats for text-based information, and/or specialized data structures for more code. A project process alteration code, in some implementations, comprises metadata and/or annotations to provide context for the changes. For example, the metadata and/or annotations comprise comments explaining the rationale behind the modifications, references to related issues and/or tickets, and/or tags indicating the scope and/or impact of the changes.

In some embodiments, the term “project process code pull request consent” refers to one or more items of data representative of an approval of a project process code pull request. A project process code pull request consent serves as a formal acknowledgment and/or authorization for proposed changes to a project process file. The technical implementation of a project process code pull request consent comprises data structures and/or processing algorithms designed to capture, store, and/or validate approval information. This might include using digital signature technologies to ensure the authenticity and/or non-repudiation of the project process code pull request consent, such as public key infrastructure (PKI) for cryptographic signing. The project process code pull request consent might be stored in secure databases, potentially using blockchain technology for an immutable audit trail of approvals.

In some embodiments, the term “revised project process file” refers to a revised version of a project process file that is updated and/or generated based on a project process code pull request and/or in response to receiving a project process code pull request consent.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

As used herein, the term “computer-readable storage medium” refers to a non-transitory, physical, or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization, or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to computer hardware and/or software that is configured to access a service made available by a server (e.g., an operation and escalation management server). The server is often (but not always) on another computer system, in which case the client device accesses the service by way of a network. Client devices may include, without limitation, smart phones, tablet computers, laptop computers, wearables, personal computers, enterprise computers, and the like.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, the terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked, or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity—relationship database, object database (e.g., S3), document database, semantic database, graph database, noSqL database (e.g., DynamoDB), and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary”, or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Example Systems and Apparatuses of the Disclosure

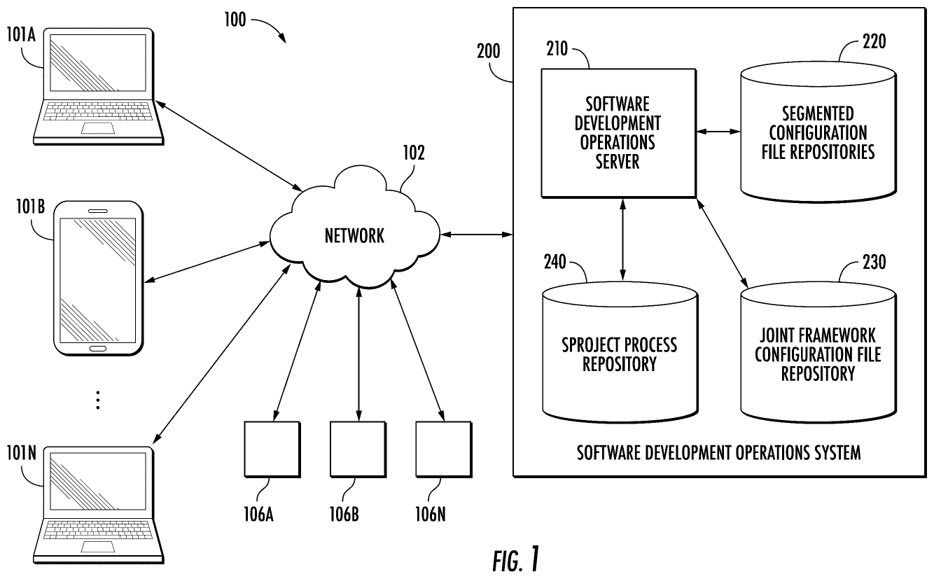

Referring now to FIG. 1, an example computing system 100 architecture within which some embodiments of the present disclosure operate is illustrated. The example computing system 100 comprises one or more software development tools 106A-106N, software development operations system 200, and a plurality of client devices 101A-101N, each communicatively connected through a communications network 102. Accordingly, user(s) (e.g., team member, individual contributor, team leader, team member, designer, etc.) may access the software development operations system 200 via the communications network 102 using one or more of client devices 101A-101N. Software development operations system 200 may comprise a software development operations server 210 in communication with at least one repository, such as a plurality of segmented configuration file repositories 220, a joint framework configuration file repository 230, and/or a project process repository 240. Such repository(ies) may be hosted by the software development operations server 210 or otherwise hosted by devices in communication with the software development operations server 210.

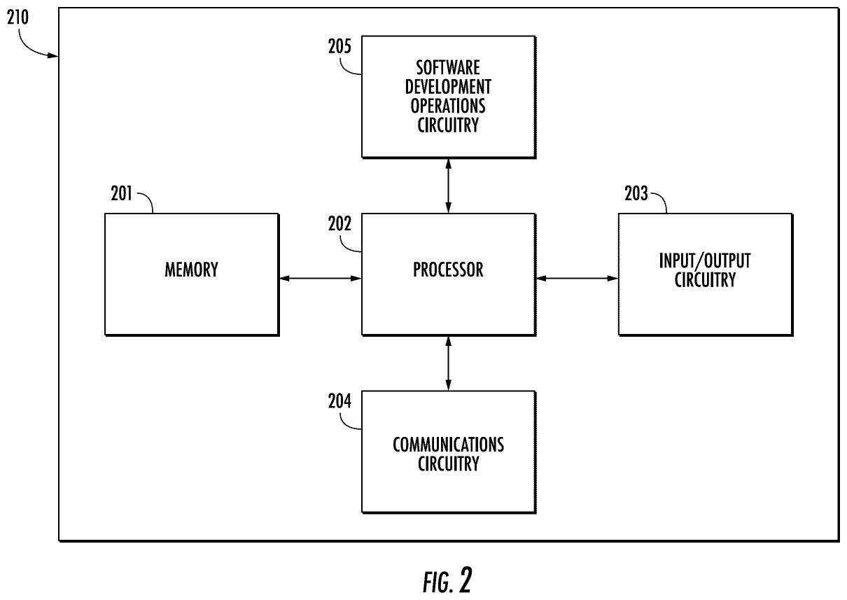

Software development operations server 210 may include circuitry, networked processors, or the like configured to perform some or all of the software development operations server-based processes described herein and may be any suitable network server and/or other type of processing device. In some embodiments, software development operations server 210 may determine and transmit commands and instructions for rendering one or more configuration code pull request operations interface to client devices 101A-101N, using data from, for example, the plurality of segmented configuration file repositories 220, the joint framework configuration file repository 230, and/or the project process repository 240. In this regard, the software development operations server 210 may be embodied by any of a variety of devices, for example, the software development operations server 210 may be embodied as a computer or a plurality of computers. For example, software development operations server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, software development operations server 210 may be located remotely from the plurality of segmented configuration file repositories 220, the joint framework configuration file repository 230, and/or the project process repository 240, although in other embodiments, the software development operations server 210 may comprise the plurality of segmented configuration file repositories 220, the joint framework configuration file repository 230, and/or the project process repository 240. The software development operations server 210 may, in some embodiments, comprise several servers or computing devices performing interconnected and/or distributed functions. Despite the many arrangements contemplated herein, software development operations server 210 is shown and described herein as a single computing device to avoid unnecessarily overcomplicating the disclosure.

Software development operations server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 702.11, IEEE 702.16, IEEE 702.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the software development operations system 200.

The plurality of segmented configuration file repositories 220, the joint framework configuration file repository 230, and/or the project process repository 240 may be stored by any suitable storage device configured to store some or all of the information described herein (e.g., memory 201 of the software development operations server 210 or a separate memory system separate from the software development operations server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. The plurality of segmented configuration file repositories 220, the joint framework configuration file repository 230, and/or the project process repository 240 may comprise data received from the software development operations server 210 (e.g., via a memory 201 and/or processor(s) 202), and the corresponding storage device may thus store this data. The plurality of segmented configuration file repositories 220, the joint framework configuration file repository 230, and/or the project process repository 240 includes information accessed and stored by the software development operations server 210 to facilitate the operations of the software development operations system 200. As such, the plurality of segmented configuration file repositories 220, the joint framework configuration file repository 230, and/or the project process repository 240 may include, for example, include framework configuration files, project configuration files, and/or project process files.

Software development tools 106A-106N may be any one or more underlying software development tools (e.g., Bitbucket®, etc.).

The client devices 101A-101N may be implemented as any computing device as defined above. Electronic data received by the software development operations server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the configuration code pull request operations interface to a user and otherwise providing access to the software development operations system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least the configuration code pull request operations interface, which may be provided by the software development operations system 200. According to further embodiments, the client devices 101A-101N may be configured to generate and/or display a configuration code pull request contrast interface component, configuration code pull request pipeline interface component, and/or the like.

In embodiments where a client device 101A-101N is a mobile device, such as a smartphone or tablet, the client device 101A-101N may execute an “app” to interact with the software development operations system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the software development operations system 200 via a web browser. As yet another example, the client devices 101A-101N may include various hardware or firmware designed to interface with the software development operations system 200.

### Example Apparatus for Implementing Embodiments of the Present Disclosure

FIG. 2 illustrates an example software development operations server 210 in accordance with at least some example embodiments of the present disclosure. In accordance with some example embodiments, software development operations server 210 may include various components, modules, circuitries, or means, some or all of which may be also or instead be included in one or more client device(s) 101A-101N. In accordance with some example embodiments, software development operations server 210 may be configured, using one or more of the sets of circuitry embodying memory 201, processor 202, input/output circuitry 203, communications circuitry 204, and/or software development operations circuitry 205 to execute and perform the operations described herein. In some embodiments, software development operations circuitry 205 is included in software development operations server 210 and/or client device 101A, the circuitry configured to facilitate the functionality discussed herein regarding generating configuration code pull request contrast interface components, configuration code pull request pipeline interface components, and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with software development operations server 210, other elements of the software development operations server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, software development operations server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., software development operations server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling the software development operations server 210 to carry out various functions in accordance with example embodiments discussed herein. For example, in at least some embodiments, memory 201 is configured to buffer data for processing by processor 202. Additionally, or alternatively, in at least some embodiments, memory 201 is configured to store program instructions for execution by processor 202. Memory 201 may store information in the form of static and/or dynamic information. This stored information may be stored and/or used by software development operations server 210 during the course of performing its functionalities.

Processor 202 may be embodied in a number of different ways and may, for example, include one or more processing devices configured to perform independently. Additionally, or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as the software development operations server 210. The plurality of processors may be in operative communication with each other and may be collectively configured to perform one or more functionalities of software development operations server 210 as described herein.

In an example embodiment, processor 202 is configured to execute instructions stored in the memory 201 or otherwise accessible to processor 202. Alternatively, or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause software development operations server 210 to perform one or more of the functionalities of software development operations server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., configuration code pull request operations interface) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in software development operations server 210 may be reduced when implemented also or instead as an end-user machine or other type of device designed for complex user interactions (i.e., client device 101). In some embodiments (like other components discussed herein), input/output circuitry 203 may even be eliminated from software development operations server 210. Alternatively, at least some aspects of input/output circuitry 203 may be embodied on an apparatus used by a user (e.g., a team member, an individual contributor, a team leader, and/or the like) that is in communication with software development operations server 210. Input/output circuitry 203 may be in communication with memory 201, communications circuitry 204, and/or any other component(s), such as via a bus. Although more than one input/output circuitry and/or other component can be included in software development operations server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with software development operations server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by software development operations server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of software development operations server 210, such as via a bus.

In some embodiments, software development operations circuitry 205 may also or instead be included and configured to perform the functionality discussed herein related to providing configuration code pull request contrast interface components, configuration code pull request pipeline interface components, and/or the like. Software development operations circuitry 205 includes hardware components and/or software configured to support interface component functionality, features, and/or services of the software development operations server 210. In some embodiments, software development operations circuitry 205 includes hardware components and/or software configured to generate, perform, cause, initiate, execute, and/or implement framework configuration file unification scripts, framework configuration file trimming scripts, project configuration file relocation scripts, and/or services of the software development operations server 210. The software development operations circuitry 205 may utilize processing circuitry, such as the processor 202, to perform its corresponding operations, and may utilize memory 201 to store collected information. The software development operations circuitry 205 may send and/or receive data from the plurality of segmented configuration file repositories 220, the joint framework configuration file repository 230, and/or the project process repository 240.

It should also be appreciated that, in some embodiments, the software development operations circuitry 205 may include a separate processor, specially configured field programmable gate array (FPGA), or application specific interface circuit (ASIC) to perform its corresponding functions. For example, in some embodiments, some or all of the functionality of software development operations circuitry 205 may be performed by processor 202. In this regard, some or all of the example processes and algorithms discussed herein can be performed by at least one processor 202 and/or software development operations circuitry 205. For example, non-transitory computer readable storage media can be configured to store firmware, one or more application programs, and/or other software, which include instructions and other computer-readable program code portions that can be executed to control processors of the components of software development operations server 210 to implement various operations, including the examples shown herein. As such, a series of computer-readable program code portions may be embodied in one or more computer program products and can be used, with a device, software development operations server 210, database, and/or other programmable apparatus, to produce the machine-implemented processes discussed herein. It is also noted that all or some of the information discussed herein can be based on data that is received, generated and/or maintained by one or more components of the software development operations server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of software development operations server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

In various embodiments of the present disclosure, an apparatus (e.g., the software development operations server 210) may be configured to generate, output, manage, and/or cause rendering of a configuration code pull request contrast interface component interface component of a software development operations system 200. For example, an apparatus (e.g., the software development operations server 210) may be configured to output and/or cause rendering of a configuration code pull request contrast interface component on a configuration code pull request operations interface 300 of the software development operations system 200.

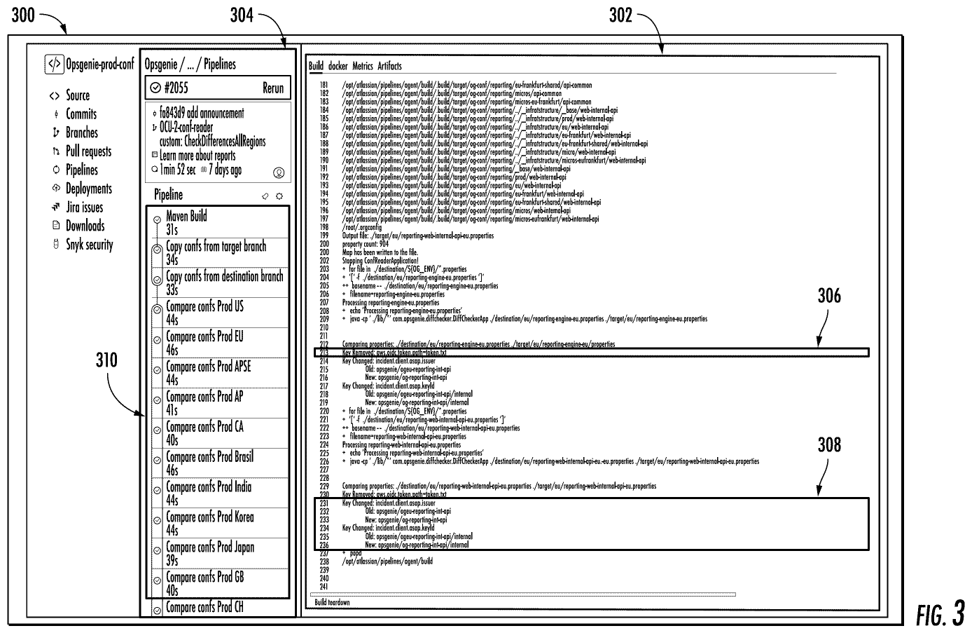

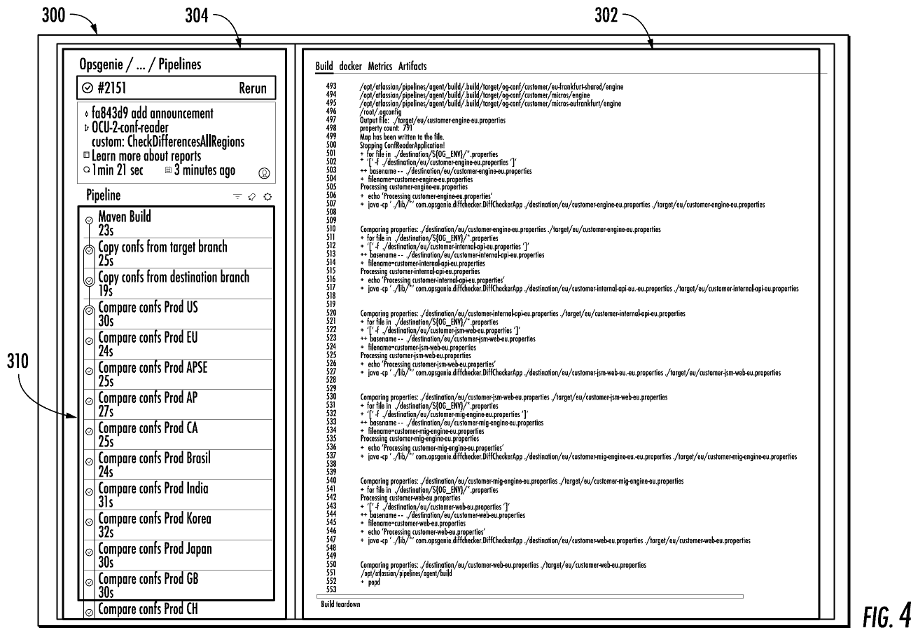

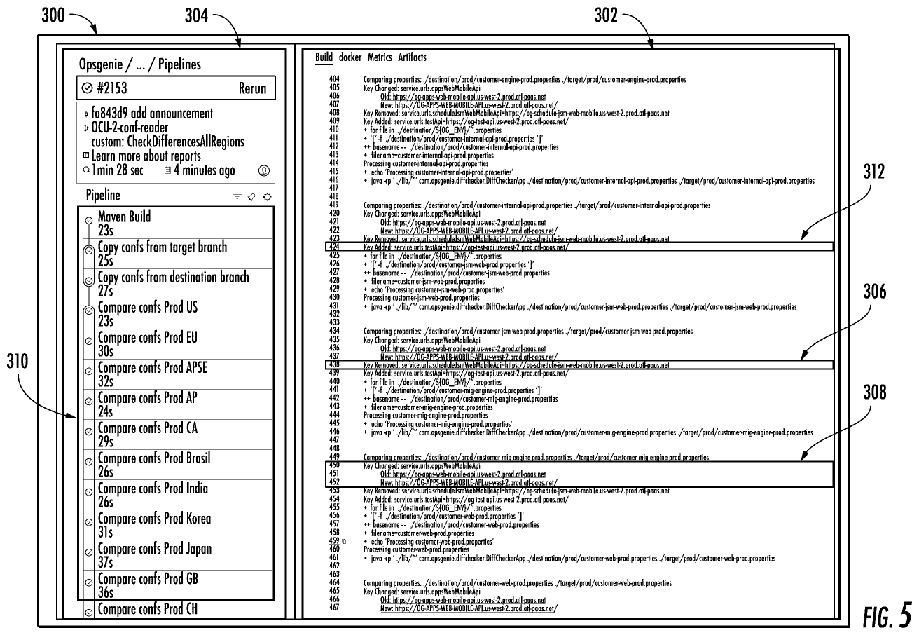

FIGS. 3-5 illustrate an example configuration code pull request contrast interface component 302 structured in accordance with various embodiments of the present disclosure. In some embodiments, the apparatus (e.g., software development operations server 210) causes rendering of the configuration code pull request contrast interface component 302 to a visual display of a computing device (e.g., a client device 101A-101N). In some embodiments, the configuration code pull request contrast interface component 302 comprises a framework configuration code contrast indicator representation. In this regard, in some embodiments, the configuration code pull request contrast interface component 302 comprises a framework configuration code contrast removal indicator representation 306. Additionally, or alternatively, the configuration code pull request contrast interface component 302 comprises a framework configuration code contrast alteration indicator representation 308. Additionally, or alternatively, the configuration code pull request contrast interface component 302 comprises a framework configuration code contrast alteration addition representation 312. For example, the configuration code pull request contrast interface component 302 may be configured to display the framework configuration code contrast removal indicator representation 306, the framework configuration code contrast alteration addition representation 312, and/or the framework configuration code contrast alteration indicator representation 308 in response to the software development operations system generating a framework configuration code contrast file.

Additionally, or alternatively, an apparatus (e.g., the software development operations server 210) may be configured to generate, output, manage, and/or cause rendering of a configuration code pull request pipeline interface component of a software development operations system 200. For example, an apparatus (e.g., the software development operations server 210) may be configured to output and/or cause rendering of a configuration code pull request pipeline interface component on a configuration code pull request operations interface 300 of the software development operations system 200.

FIGS. 3-5 illustrate an example configuration code pull request pipeline interface component 304 structured in accordance with various embodiments of the present disclosure. In some embodiments, the apparatus (e.g., software development operations server 210) causes rendering of the configuration code pull request pipeline interface component 304 to a visual display of a computing device (e.g., a client device 101A-101N). In some embodiments, the configuration code pull request pipeline interface component 304 comprises a framework configuration code contrast file progress indicator representation 310. In some embodiments, the software development operations server 210 is configured to display the configuration code pull request pipeline interface component 304 in response to an instruction to generate a framework configuration code contrast file.

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

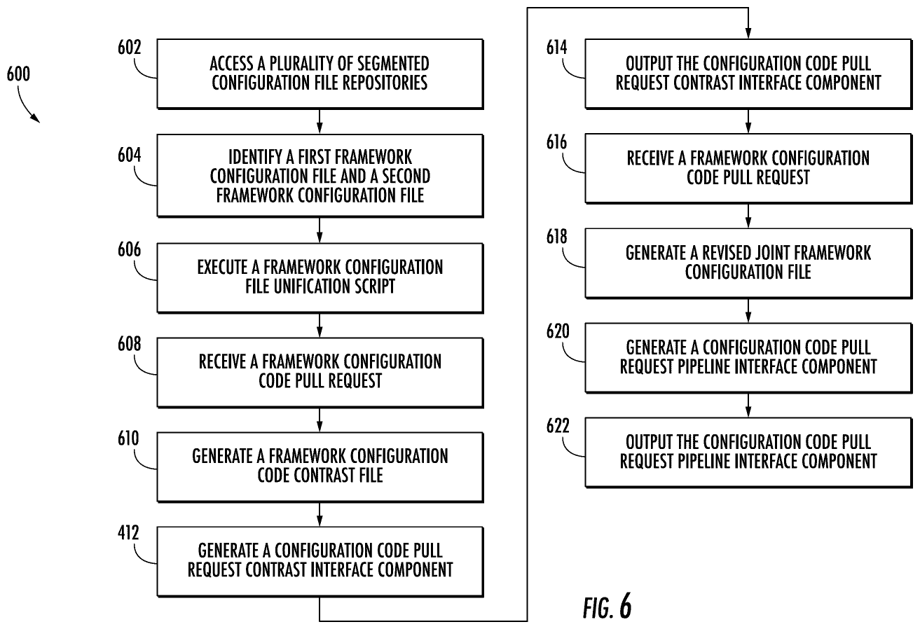

FIG. 6 is a flowchart broadly illustrating a series of operations or process blocks that are executed or performed to output one or more interface components, such as a configuration code pull request contrast interface component and/or a configuration code pull request pipeline interface component, in accordance with some example embodiments of the present disclosure. In some embodiments, the method 600 is embodied by computer program code stored on a non-transitory computer-readable storage medium of a computer program product configured for execution to perform the process as depicted and described. In this regard, in some such embodiments, the software development operations server 210 is specially configured by computer-coded instructions (e.g., computer program instructions) stored thereon, for example in the memory 201 and/or another component depicted and/or described herein and/or otherwise accessible to the software development operations server 210, for performing the operations as depicted and described. Alternatively, or additionally, in some embodiments, the method 600 is performed by one or more specially configured computing devices, such as the software development operations server 210 alone or in communication with one or more other component(s), device(s), system(s), and/or the like. For example, in some embodiments, the software development operations server 210 is in communication with one or more external apparatus(es), system(s), device(s), and/or the like, to perform one or more of the operations as depicted and described. For purposes of simplifying the description, the method 600 is described as performed by and from the perspective of the software development operations server 210. In this regard, performance of the operations may invoke one or more of memory 201, processor 202, input/output circuitry 203, communications circuitry 204, and/or software development operations circuitry 205.

In the embodiment illustrated in FIG. 6, the flowchart illustrates method 600 which begins at block 602. At block 602, the software development operations server 210, includes means, such as the memory 201, processor 202, input/output circuitry 203, communications circuitry 204, and/or software development operations circuitry 205, or a combination thereof, to access a plurality of segmented configuration file repositories.

At block 604, the software development operations server 210, includes means, such as the memory 201, processor 202, input/output circuitry 203, communications circuitry 204, and/or software development operations circuitry 205, or a combination thereof, to identify a first framework configuration file and a second framework configuration file. For example, the software development operations server 210 may be configured to identify a first framework configuration file in a first segmented configuration file repository of the plurality of segmented configuration file repositories and a second framework configuration file in a second segmented configuration file repository of the plurality of segmented configuration file repositories.

At block 606, the software development operations server 210, includes means, such as the memory 201, processor 202, input/output circuitry 203, communications circuitry 204, and/or software development operations circuitry 205, or a combination thereof, to execute a framework configuration file unification script. For example, the software development operations server 210 may be configured to execute a framework configuration file unification script to transfer the first framework configuration file to a first framework configuration file directory in a joint framework configuration file repository and the second framework configuration file to a second framework configuration file directory in the joint framework configuration file repository.

At block 608, the software development operations server 210, includes means, such as the memory 201, processor 202, input/output circuitry 203, communications circuitry 204, and/or software development operations circuitry 205, or a combination thereof, to receive a framework configuration code pull request. For example, the software development operations server 210 may be configured to receive a framework configuration code pull request corresponding to the first framework configuration file. In some embodiments, the framework configuration code pull request comprises a framework configuration alteration code.

At block 610, the software development operations server 210, includes means, such as the memory 201, processor 202, input/output circuitry 203, communications circuitry 204, and/or software development operations circuitry 205, or a combination thereof, to generate a framework configuration code contrast file. For example, the software development operations server 210 may be configured to generate a framework configuration code contrast file by applying the framework configuration code pull request and a joint framework configuration file to a framework configuration code contrast model. In some embodiments, the framework configuration code contrast file comprises a framework configuration code contrast indicator.

At block 612, the software development operations server 210, includes means, such as the memory 201, processor 202, input/output circuitry 203, communications circuitry 204, and/or software development operations circuitry 205, or a combination thereof, to generate a configuration code pull request contrast interface component. In some embodiments, the configuration code pull request contrast interface component comprises a framework configuration code contrast indicator representation corresponding to the framework configuration code contrast indicator.

At block 614, the software development operations server 210, includes means, such as the memory 201, processor 202, input/output circuitry 203, communications circuitry 204, and/or software development operations circuitry 205, or a combination thereof, to output the configuration code pull request contrast interface component. For example, the software development operations server 210 may be configured to output the configuration code pull request contrast interface component for rendering to the configuration code pull request operations interface.

At block 616, the software development operations server 210, includes means, such as the memory 201, processor 202, input/output circuitry 203, communications circuitry 204, and/or software development operations circuitry 205, or a combination thereof, to receive a framework configuration code pull request. For example, the software development operations server 210 may be configured to receive a framework configuration code pull request from a client device.

At block 618, the software development operations server 210, includes means, such as the memory 201, processor 202, input/output circuitry 203, communications circuitry 204, and/or software development operations circuitry 205, or a combination thereof, to generate a revised joint framework configuration file. For example, the software development operations server 210 may be configured to generate a revised joint framework configuration file based on the framework configuration alteration code.

At block 620, the software development operations server 210, includes means, such as the memory 201, processor 202, input/output circuitry 203, communications circuitry 204, and/or software development operations circuitry 205, or a combination thereof, to generate a configuration code pull request pipeline interface component. In some embodiments, the configuration code pull request pipeline interface component comprises a framework configuration code contrast file progress indicator representation corresponding to the first framework configuration file.

At block 622, the software development operations server 210, includes means, such as the memory 201, processor 202, input/output circuitry 203, communications circuitry 204, and/or software development operations circuitry 205, or a combination thereof, to output the configuration code pull request pipeline interface component. For example, the software development operations server 210 may be configured to output the configuration code pull request pipeline interface component for rendering to the configuration code pull request operations interface.

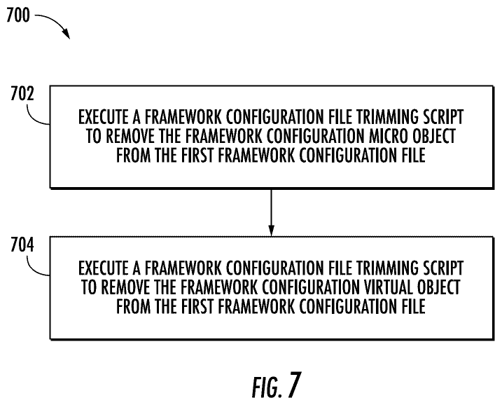

FIG. 7 is a flowchart broadly illustrating a series of operations or process blocks that are executed or performed to execute a framework configuration file trimming script in accordance with some example embodiments of the present disclosure. In some embodiments, the method 700 is embodied by computer program code stored on a non-transitory computer-readable storage medium of a computer program product configured for execution to perform the process as depicted and described. In this regard, in some such embodiments, the software development operations server 210 is specially configured by computer-coded instructions (e.g., computer program instructions) stored thereon, for example in the memory 201 and/or another component depicted and/or described herein and/or otherwise accessible to the software development operations server 210, for performing the operations as depicted and described. Alternatively, or additionally, in some embodiments, the method 700 is performed by one or more specially configured computing devices, such as the software development operations server 210 alone or in communication with one or more other component(s), device(s), system(s), and/or the like. For example, in some embodiments, the software development operations server 210 is in communication with one or more external apparatus(es), system(s), device(s), and/or the like, to perform one or more of the operations as depicted and described. For purposes of simplifying the description, the method 700 is described as performed by and from the perspective of the software development operations server 210. In this regard, performance of the operations may invoke one or more of memory 201, processor 202, input/output circuitry 203, communications circuitry 204, and/or software development operations circuitry 205.

In the embodiment illustrated in FIG. 7, the flowchart illustrates method 700 which begins at block 702. At block 702, the software development operations server 210, includes means, such as the memory 201, processor 202, input/output circuitry 203, communications circuitry 204, and/or software development operations circuitry 205, or a combination thereof, to execute a framework configuration file trimming script to remove the framework configuration micro object from the first framework configuration file.

At block 704, the software development operations server 210, includes means, such as the memory 201, processor 202, input/output circuitry 203, communications circuitry 204, and/or software development operations circuitry 205, or a combination thereof, to execute a framework configuration file trimming script to remove the framework configuration virtual object from the first framework configuration file. is a flowchart broadly illustrating a series of operations or process blocks that are executed or performed to deploy a project process file and a revised project configuration file and/or deploy a project configuration file and/or a revised project process file in accordance with some example embodiments of the present disclosure. In some embodiments, the method 800 is embodied by computer program code stored on a non-transitory computer-readable storage medium of a computer program product configured for execution to perform the process as depicted and described. In this regard, in some such embodiments, the software development operations server 210 is specially configured by computer-coded instructions (e.g., computer program instructions) stored thereon, for example in the memory 201 and/or another component depicted and/or described herein and/or otherwise accessible to the software development operations server 210, for performing the operations as depicted and described. Alternatively, or additionally, in some embodiments, the method 800 is performed by one or more specially configured computing devices, such as the software development operations server 210 alone or in communication with one or more other component(s), device(s), system(s), and/or the like. For example, in some embodiments, the software development operations server 210 is in communication with one or more external apparatus(es), system(s), device(s), and/or the like, to perform one or more of the operations as depicted and described. For purposes of simplifying the description, the method 800 is described as performed by and from the perspective of the software development operations server 210. In this regard, performance of the operations may invoke one or more of memory 201, processor 202, input/output circuitry 203, communications circuitry 204, and/or software development operations circuitry 205.

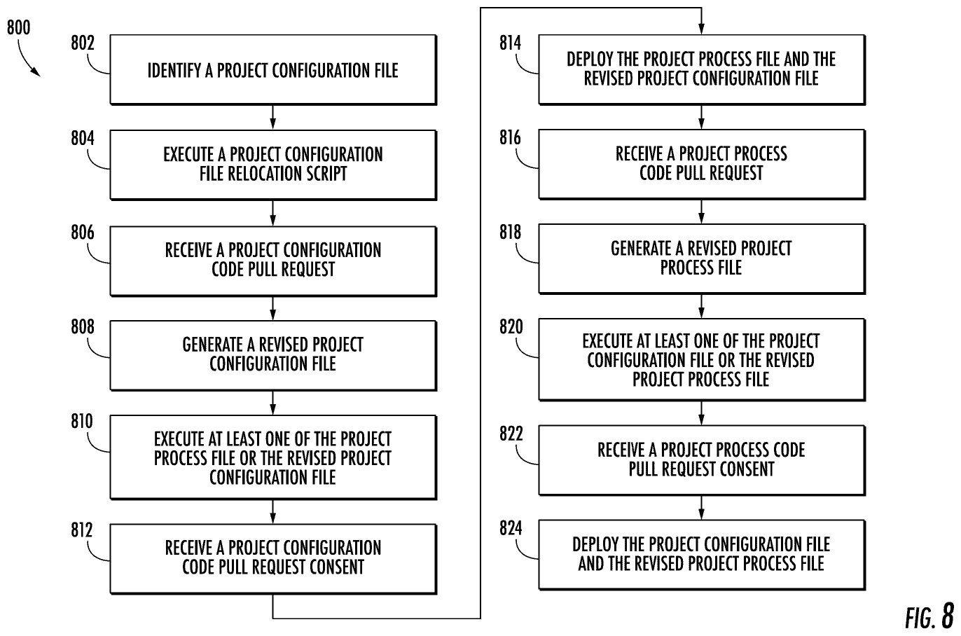

In the embodiment illustrated in FIG. 8, the flowchart illustrates method 800 which begins at block 802. At block 802, the software development operations server 210, includes means, such as the memory 201, processor 202, input/output circuitry 203, communications circuitry 204, and/or software development operations circuitry 205, or a combination thereof, to identify a project configuration file. For example, the software development operations server 210 may be configured to identify a project configuration file in at least one of the plurality of segmented configuration file repositories.

At block 804, the software development operations server 210, includes means, such as the memory 201, processor 202, input/output circuitry 203, communications circuitry 204, and/or software development operations circuitry 205, or a combination thereof, to execute a project configuration file relocation script. For example, the software development operations server 210 may be configured to execute a project configuration file relocation script to transfer the project configuration file to a project configuration file directory in a project process repository.

At block 806, the software development operations server 210, includes means, such as the memory 201, processor 202, input/output circuitry 203, communications circuitry 204, and/or software development operations circuitry 205, or a combination thereof, to receive a project configuration code pull request. For example, the software development operations server 210 may be configured to receive a project configuration code pull request corresponding to the project configuration file. In some embodiments, the project configuration code pull request comprises a project configuration alteration code.

At block 808, the software development operations server 210, includes means, such as the memory 201, processor 202, input/output circuitry 203, communications circuitry 204, and/or software development operations circuitry 205, or a combination thereof, to generate a revised project configuration file. For example, the software development operations server 210 may be configured to generate a revised project configuration file based on the project configuration alteration code.

At block 810, the software development operations server 210, includes means, such as the memory 201, processor 202, input/output circuitry 203, communications circuitry 204, and/or software development operations circuitry 205, or a combination thereof, to execute at least one of the project process file or the revised project configuration file.

At block 812, the software development operations server 210, includes means, such as the memory 201, processor 202, input/output circuitry 203, communications circuitry 204, and/or software development operations circuitry 205, or a combination thereof, to receive a project configuration code pull request consent.

At block 814, the software development operations server 210, includes means, such as the memory 201, processor 202, input/output circuitry 203, communications circuitry 204, and/or software development operations circuitry 205, or a combination thereof, to deploy the project process file and the revised project configuration file. For example, the software development operations server 210 may be configured to deploy the project process file and the revised project configuration file to a project production execution environment.

At block 816, the software development operations server 210, includes means, such as the memory 201, processor 202, input/output circuitry 203, communications circuitry 204, and/or software development operations circuitry 205, or a combination thereof, to receive a project process code pull request. For example, the software development operations server 210 may be configured to receive a project process code pull request corresponding to the project process file. In some embodiments, the project process code pull request comprises a project process alteration code.

At block 818, the software development operations server 210, includes means, such as the memory 201, processor 202, input/output circuitry 203, communications circuitry 204, and/or software development operations circuitry 205, or a combination thereof, to generate a revised project process file. For example, the software development operations server 210 may be configured to generate a revised project process file based on the project process alteration code.

At block 820, the software development operations server 210, includes means, such as the memory 201, processor 202, input/output circuitry 203, communications circuitry 204, and/or software development operations circuitry 205, or a combination thereof, to execute at least one of the project configuration file or the revised project process file.

At block 822, the software development operations server 210, includes means, such as the memory 201, processor 202, input/output circuitry 203, communications circuitry 204, and/or software development operations circuitry 205, or a combination thereof, to receive a project process code pull request consent.

At block 824, the software development operations server 210, includes means, such as the memory 201, processor 202, input/output circuitry 203, communications circuitry 204, and/or software development operations circuitry 205, or a combination thereof, to deploy the project configuration file and the revised project process file. For example, the software development operations server 210 may be configured to deploy the project configuration file and the revised project process file to a project process production execution environment.

FIGS. 6, 7, and 8 thus illustrate flowcharts describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the software development operations server 210 and executed by a processor 202 of the software development operations server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Conclusion

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus configured for outputting a configuration code pull request contrast interface component for rendering to a configuration code pull request operations interface, the apparatus comprising at least one processor, and at least one memory including program code, the at least one memory and the program code configured to, with the at least one processor, cause the apparatus to at least:
access a plurality of segmented configuration file repositories;
identify a first framework configuration file in a first segmented configuration file repository of the plurality of segmented configuration file repositories and a second framework configuration file in a second segmented configuration file repository of the plurality of segmented configuration file repositories;
execute a framework configuration file unification script to transfer the first framework configuration file to a first framework configuration file directory in a joint framework configuration file repository and the second framework configuration file to a second framework configuration file directory in the joint framework configuration file repository;
receive a framework configuration code pull request corresponding to the first framework configuration file;
generate a framework configuration code contrast file by applying the framework configuration code pull request and a joint framework configuration file to a framework configuration code contrast model, wherein the framework configuration code contrast file comprises a framework configuration code contrast indicator;
generate the configuration code pull request contrast interface component, wherein the configuration code pull request contrast interface component comprises a framework configuration code contrast indicator representation corresponding to the framework configuration code contrast indicator; and
output the configuration code pull request contrast interface component for rendering to the configuration code pull request operations interface.

2. The apparatus of claim 1, wherein the program code is further configured to, with the at least one processor, cause the apparatus to:
generate a configuration code pull request pipeline interface component, wherein the configuration code pull request pipeline interface component comprises a framework configuration code contrast file progress indicator representation corresponding to the first framework configuration file; and
output the configuration code pull request pipeline interface component for rendering to the configuration code pull request operations interface.

3. The apparatus of claim 1, wherein the framework configuration code contrast indicator representation comprises at least one of a framework configuration code contrast removal indicator representation or a framework configuration code contrast alteration indicator representation.

4. The apparatus of claim 1, wherein the first framework configuration file comprises a framework configuration micro object and wherein the program code is further configured to, with the at least one processor, cause the apparatus to:
execute a framework configuration file trimming script to remove the framework configuration micro object from the first framework configuration file.

5. The apparatus of claim 1, wherein the first framework configuration file comprises a framework configuration virtual object and wherein the program code is further configured to, with the at least one processor, cause the apparatus to:
execute a framework configuration file trimming script to remove the framework configuration virtual object from the first framework configuration file.

6. The apparatus of claim 1, wherein the plurality of segmented configuration file repositories comprise a segmented production configuration file repository or a segmented staging configuration file repository.

7. The apparatus of claim 1, wherein the framework configuration code pull request comprises a framework configuration alteration code and wherein the program code is further configured to, with the at least one processor, cause the apparatus to:
receive a framework configuration code pull request consent; and
generate a revised joint framework configuration file based on the framework configuration alteration code.

8. The apparatus of claim 1, wherein the program code is further configured to, with the at least one processor, cause the apparatus to:
identify a project configuration file in at least one of the plurality of segmented configuration file repositories; and
execute a project configuration file relocation script to transfer the project configuration file to a project configuration file directory in a project process repository.

9. The apparatus of claim 8, wherein the project process repository comprises a project process file and wherein the program code is further configured to, with the at least one processor, cause the apparatus to:
receive a project configuration code pull request corresponding to the project configuration file, wherein the project configuration code pull request comprises a project configuration alteration code;
generate a revised project configuration file based on the project configuration alteration code;
execute at least one of the project process file or the revised project configuration file;
receive a project configuration code pull request consent; and
deploy the project process file and the revised project configuration file to a project production execution environment.

10. The apparatus of claim 8, wherein the project process repository comprises a project process file and wherein the program code is further configured to, with the at least one processor, cause the apparatus to:
receive a project process code pull request corresponding to the project process file, wherein the project process code pull request comprises a project process alteration code;
generate a revised project process file based on the project process alteration code;
execute at least one of the project configuration file or the revised project process file;
receive a project process code pull request consent; and
deploy the project configuration file and the revised project process file to a project process production execution environment.

11. A method for outputting a configuration code pull request contrast interface component for rendering to a configuration code pull request operations interface, the method comprising:
accessing a plurality of segmented configuration file repositories;
identifying a first framework configuration file in a first segmented configuration file repository of the plurality of segmented configuration file repositories and a second framework configuration file in a second segmented configuration file repository of the plurality of segmented configuration file repositories;
executing a framework configuration file unification script to transfer the first framework configuration file to a first framework configuration file directory in a joint framework configuration file repository and the second framework configuration file to a second framework configuration file directory in the joint framework configuration file repository;
receiving a framework configuration code pull request corresponding to the first framework configuration file;
generating a framework configuration code contrast file by applying the framework configuration code pull request and a joint framework configuration file to a framework configuration code contrast model, wherein the framework configuration code contrast file comprises a framework configuration code contrast indicator;
generating the configuration code pull request contrast interface component, wherein the configuration code pull request contrast interface component comprises a framework configuration code contrast indicator representation corresponding to the framework configuration code contrast indicator, wherein the framework configuration code contrast indicator representation comprises at least one of a framework configuration code contrast removal indicator representation or a framework configuration code contrast alteration indicator representation; and
outputting the configuration code pull request contrast interface component for rendering to the configuration code pull request operations interface.

12. The method of claim 11, further comprising:
generating a configuration code pull request pipeline interface component, wherein the configuration code pull request pipeline interface component comprises a framework configuration code contrast file progress indicator representation corresponding to the first framework configuration file; and
outputting the configuration code pull request pipeline interface component for rendering to the configuration code pull request operations interface.

13. The method of claim 11, wherein the first framework configuration file comprises a framework configuration micro object and the method further comprises:
executing a framework configuration file trimming script to remove the framework configuration micro object from the first framework configuration file.

14. The method of claim 11, wherein the first framework configuration file comprises a framework configuration virtual object and the method further comprises:
executing a framework configuration file trimming script to remove the framework configuration virtual object from the first framework configuration file.

15. The method of claim 11, wherein the plurality of segmented configuration file repositories comprise a segmented production configuration file repository or a segmented staging configuration file repository.

16. The method of claim 11, wherein the framework configuration code pull request comprises a framework configuration alteration code and the method further comprises:
receiving a framework configuration code pull request consent; and
generating a revised joint framework configuration file based on the framework configuration alteration code.

17. The method of claim 11, further comprising:
identifying a project configuration file in at least one of the plurality of segmented configuration file repositories; and
executing a project configuration file relocation script to transfer the project configuration file to a project configuration file directory in a project process repository.

18. The method of claim 17, wherein the project process repository comprises a project process file and the method further comprises:
receiving a project configuration code pull request corresponding to the project configuration file, wherein the project configuration code pull request comprises a project configuration alteration code;
generating a revised project configuration file based on the project configuration alteration code;
executing at least one of the project process file or the revised project configuration file;
receiving a project configuration code pull request consent; and
deploying the project process file and the revised project configuration file to a project process production execution environment.

19. The method of claim 17, wherein the project process repository comprises a project process file and the method further comprises:
receiving a project process code pull request corresponding to the project process file, wherein the project process code pull request comprises a project process alteration code;
generating a revised project process file based on the project process alteration code;
executing at least one of the project configuration file or the revised project process file;
receiving a project process code pull request consent; and
deploying the project configuration file and the revised project process file to a project process production execution environment.

20. A computer program product for outputting a configuration code pull request contrast interface component for rendering to a configuration code pull request operations interface, the computer program product comprising at least one non-transitory computer-readable storage medium having computer-readable program code portions stored therein, the computer-readable program code portions comprising an executable portion configured to:
access a plurality of segmented configuration file repositories, wherein the plurality of segmented configuration file repositories comprise a segmented production configuration file repository or a segmented staging configuration file repository;
identify a first framework configuration file in a first segmented configuration file repository of the plurality of segmented configuration file repositories and a second framework configuration file in a second segmented configuration file repository of the plurality of segmented configuration file repositories;
execute a framework configuration file unification script to transfer the first framework configuration file to a first framework configuration file directory in a joint framework configuration file repository and the second framework configuration file to a second framework configuration file directory in the joint framework configuration file repository;
receive a framework configuration code pull request corresponding to the first framework configuration file;
generate a framework configuration code contrast file by applying the framework configuration code pull request and a joint framework configuration file to a framework configuration code contrast model, wherein the framework configuration code contrast file comprises a framework configuration code contrast indicator;
generate the configuration code pull request contrast interface component, wherein the configuration code pull request contrast interface component comprises a framework configuration code contrast indicator representation corresponding to the framework configuration code contrast indicator; and
output the configuration code pull request contrast interface component for rendering to the configuration code pull request operations interface.
